(19) United States
(12) Patent Application Publication
(10) Pub. No.: US 2024/0137796 A1
(43) Pub. Date: Apr. 25, 2024

(54) MEASUREMENT GAP SETTING

(71) Applicant: Nokia Solutions and Networks Oy, Espoo (FI)

(72) Inventors: Muhammad TAYYAB, Oulu (FI); Muhammad Majid BUTT, Naperville, IL (US); Halit Murat GÜRSU, Munich (DE)

(21) Appl. No.: 18/546,403

(22) PCT Filed: Feb. 25, 2022
(86) PCT No.: PCT/EP2022/054856

§ 371 Date: Aug. 13, 2023

(30) Foreign Application Priority Data
Mar. 10, 2021 (FI) 20215258

(51) Int. Cl. H04W 24/10; H04W 36/00

(52) U.S. Cl. CPC H04W 24/10; H04W 36/0088

(57) ABSTRACT

An apparatus, method and computer program is described comprising: receiving mobile communication network data for a user device; providing the received mobile communication network data to a model for generating a measurement gap setting based on the received data, wherein the measurement gap setting defines measurement gap parameters for use in scheduling radio measurements of neighbouring cells; and returning the generated measurement gap setting.

### FIELD

The present specification relates to measurement gaps in mobile communication systems.

### BACKGROUND

A mechanism may be provided in a mobile communication system to determine whether an existing communication node that a user device is communicating with should be changed. A number of arrangements, including the setting of a measurement gap, can be used to control how and when a user device determines whether to change the communication node with which it is communicating. There remains a need for further developments in this field.

### SUMMARY

In a first aspect, this specification describes an apparatus comprising means for performing: receiving mobile communication network data for a user device; providing the received mobile communication network data to a model for generating a measurement gap setting based on the received data, wherein the measurement gap setting defines measurement gap parameters for use in scheduling radio measurements of neighbouring cells; and returning the generated measurement gap setting.

The measurement gap parameters may define one or more of intra-frequency, inter-frequency and inter-radio access technology measurements.

The measurement gap setting may comprise a measurement gap repetition rate defining a periodicity of measurements. Alternatively, or in addition, the measurement gap setting comprises a measurement gap length.

In some example embodiments, the measurement gap setting comprises one of a predefined plurality of measurement gap patterns.

The mobile communication network data may comprise one or more of: current location data for the user device; serving cell Reference Signal Received Power; user device bandwidth; radio resource management relaxation state; and a current mobility state of the user device. The current location data for the user device may indicate whether the device is at a cell centre, at cell edge or in-between the cell centre and cell edge.

The said model may be a machine learning model. Some example embodiments further comprise means for performing training said machine learning model. For example, the means for performing training said machine learning model may comprise means for performing: obtaining a set of input data from the user device; labelling the data, including indicating whether a handover occurred; and training the model by minimising a loss function.

In a second aspect, this specification describes an apparatus comprising means for performing: obtaining a set of input data from a user device that is in communication with a mobile communication network; labelling the data, including indicating whether a handover occurred; and training a model (e.g. a machine learning model) for generating a measurement gap setting, wherein the measurement gap setting defines measurement gap parameters for use in scheduling radio measurements of neighbouring cells, wherein training the model comprises minimising a loss function. The measurement gap setting may comprise a measurement gap repetition rate defining a periodicity of measurements and/or a measurement gap length. In some example embodiments, the measurement gap setting comprises one of a predefined plurality of measurement gap patterns.

The input data may comprises one or more of: current location data for the user device; serving cell Reference Signal Received Power; user device bandwidth; radio resource management relaxation state; and a current mobility state of the user device. The current location data for the user device may indicate whether the device is at a cell centre, at cell edge or in-between the cell centre and cell edge.

In the first and second aspects, the means may comprise at least one processor and at least one memory including computer program code. The at least one memory and the computer program code may be configured to, with the at least one processor, cause the performance of the apparatus.

In a third aspect, this specification describes a method comprising: receiving mobile communication network data for a user device; providing the received mobile communication network data to a model for generating a measurement gap setting based on the received data, wherein the measurement gap setting defines measurement gap parameters for use in scheduling radio measurements of neighbouring cells; and returning the generated measurement gap setting. The measurement gap setting may comprise a measurement gap repetition rate defining a periodicity of measurements and/or a measurement gap length. In some example embodiments, the measurement gap setting comprises one of a predefined plurality of measurement gap patterns.

The said model may be a machine learning model. Some example embodiments further comprise training said machine learning model.

In a fourth aspect, this specification describes a method comprising: obtaining a set of input data from a user device that is in communication with a mobile communication network; labelling the data, including indicating whether a handover occurred; and training a model (e.g. a machine learning model) for generating a measurement gap setting, wherein the measurement gap setting defines measurement gap parameters for use in scheduling radio measurements of neighbouring cells, wherein training the model comprises minimising a loss function. The measurement gap setting may comprise a measurement gap repetition rate defining a periodicity of measurements and/or a measurement gap length. In some example embodiments, the measurement gap setting comprises one of a predefined plurality of measurement gap patterns.

In a fifth aspect, this specification describes computer-readable instructions which, when executed by computing apparatus, cause the computing apparatus to perform (at least) any method as described with reference to the third or fourth aspects.

In a sixth aspect, this specification describes a computer-readable medium (such as a non-transitory computer-readable medium) comprising program instructions stored thereon for performing (at least) any method as described with reference to the third or fourth aspects.

In a seventh aspect, this specification describes an apparatus comprising: at least one processor; and at least one memory including computer program code which, when executed by the at least one processor, causes the apparatus to perform (at least) any method as described with reference to the third or fourth aspect.

In an eighth aspect, this specification describes a computer program comprising instructions for causing an apparatus to perform at least the following: receiving mobile communication network data for a user device; providing the received mobile communication network data to a model for generating a measurement gap setting based on the received data, wherein the measurement gap setting defines measurement gap parameters for use in scheduling radio measurements of neighbouring cells; and returning the generated measurement gap setting.

In a ninth aspect, this specification describes a computer program comprising instructions for causing an apparatus to perform at least the following: obtaining a set of input data from a user device that is in communication with a mobile communication network; labelling the data, including indicating whether a handover occurred; and training a model (e.g. a machine learning model) for generating a measurement gap setting, wherein the measurement gap setting defines measurement gap parameters for use in scheduling radio measurements of neighbouring cells, wherein training the model comprises minimising a loss function.

In a tenth aspect, this specification describes: a first input (or some other means) for receiving mobile communication network data for a user device; a first output (or some other means) for providing the received mobile communication network data to a model for generating a measurement gap setting based on the received data, wherein the measurement gap setting defines measurement gap parameters for use in scheduling radio measurements of neighbouring cells; and a second output (or some other means) for returning the generated measurement gap setting.

In an eleventh aspect, this specification describes: a database (or some other means) for obtaining a set of input data from a user device that is in communication with a mobile communication network; a data labelling module (or some other means) for labelling the data, including indicating whether a handover occurred; and a training module (or some other means) for training a model (e.g. a machine learning model) for generating a measurement gap setting, wherein the measurement gap setting defines measurement gap parameters for use in scheduling radio measurements of neighbouring cells, wherein training the model comprises minimising a loss function.

### BRIEF DESCRIPTION OF THE DRAWINGS

Example embodiments will now be described, by way of example only, with reference to the following schematic drawings, in which:

FIG. 1 is a block diagram of a system in accordance with an example embodiment;

FIG. 2 shows a series of frames in accordance with an example embodiment;

FIG. 3 is a flow chart showing an algorithm in accordance with an example embodiment;

FIG. 4 is a flow chart showing an algorithm in accordance with an example embodiment;

FIG. 5 is a block diagram of a system in accordance with an example embodiment;

FIG. 6 is a block diagram of a system in accordance with an example embodiment;

FIG. 7 is a message sequence in accordance with an example embodiment;

FIGS. 8 to 10 are plots showing throughputs for user devices in accordance with example embodiments;

FIG. 11 is a block diagram of components of a system in accordance with an example embodiment; and

FIGS. 12A and 12B show tangible media, respectively a removable non-volatile memory unit and a compact disc (CD) storing computer-readable code which when run by a computer perform operations according to example embodiment.

### DETAILED DESCRIPTION

The scope of protection sought for various embodiments of the invention is set out by the independent claims. The embodiments and features, if any, described in the specification that do not fall under the scope of the independent claims are to be interpreted as examples useful for understanding various embodiments of the invention.

In the description and drawings, like reference numerals refer to like elements throughout.

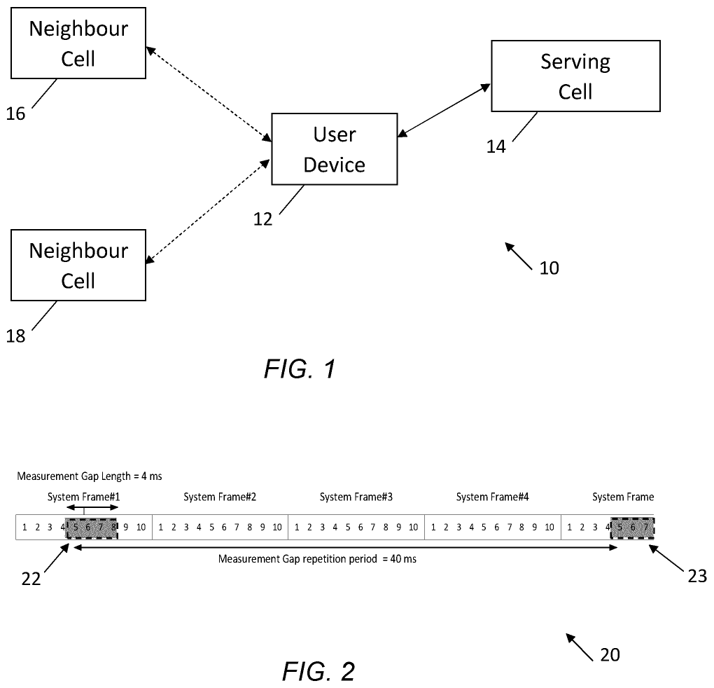

FIG. 1 is a block diagram of a system, indicated generally by the reference numeral 10, in accordance with an example embodiment. The system 10 comprises a user device 12, a serving cell 14, a first neighbour cell 16 and a second neighbour cell 18. As indicated by the solid arrow, the user device 12 is in two-way communication with the serving cell 14. The user device 14 may also exchange information with the first and second neighbour cells 16 and 18, for example to determine whether one of those neighbour cells should be used as the serving cell instead of the serving cell 14.

The user device 12 may identify and measure intra-frequency cells and/or inter-frequency cells and/or inter-RAT E-UTRAN cells based on measurement gap (MG) information provided by a network. During these measurements, the user device 12 stops transmission and reception with the serving cell 14 and measures the neighbouring cells. Such measurements may take place periodically, based on a measurement gap repetition period (MGRP). Example MGRPs might be 20, 40, 80 or 160 ms. Similarly, each measurement gap may have a fixed duration, referred to as a measurement gap length (MGL). Example measurement gaps lengths are 1.5, 3, 3.5, 4, 5.5 or 6 ms.

A combination of a measurement gap repetition period (MGRP) and a measurement gap length (MGL) define a measurement gap pattern (MGP).

FIG. 2 shows a series of frames, indicated generally by the reference numeral 20, in accordance with an example embodiment. The frames 20 comprise first to fifth system frames.

Most of the communications shown in the frames 20 are between the relevant user device and the serving cell (e.g. the user device 12 and the serving cell 14 described above). A first measurement gap 22 is shown in the first system frame and a second measurement gap 23 is shown in the fifth system frame. Both measurements gaps have a measurement gap length of 4 ms. The measurement gap period (sometimes referred to as a measurement gap repetition period) is 40 ms. Thus, in the example frames 20, the measurement gap pattern (MGP) comprises a measurement gap length of 4 ms and a measurement gap period of 40 ms.

In some example embodiments, a plurality of predefined measurement gap patterns (each defining a measurement gap length and a measurement gap period) are available for selection. However, it may also be possible to define measurement gap patterns that are not predefined.

The measurement gap repetition period (MGRP) may be set to match a Synchronization Signal Block (SSB) periodicity and the measurement gap length (MGL) may be set to match duration of the neighbour SSBs that the user device seeks to measure. During the MGL the serving cell should not schedule the user device for downlink resources, but whether a measurement is done within a measurement gap or not may be left up to user device implementation.

It should be noted that the throughput of the user device 12 is limited, since the serving cell does not schedule data transmission during the measurement periods. If the measurement gap patterns are not properly configured, this can lead to high throughput loss and/or handover failures (HOFs). For example, if the measurement gap repetition period (MGRP) is increased from 80 ms to 160 ms, this might improve throughput, but increase HOFs (due infrequent neighbouring cell measurements), for example if the user device is at a cell edge. In contrast, reducing the MGRP from 80 ms to 20 ms may reduce the HOFs, but reduce the throughput (e.g. when the user device is near the centre of a cell).

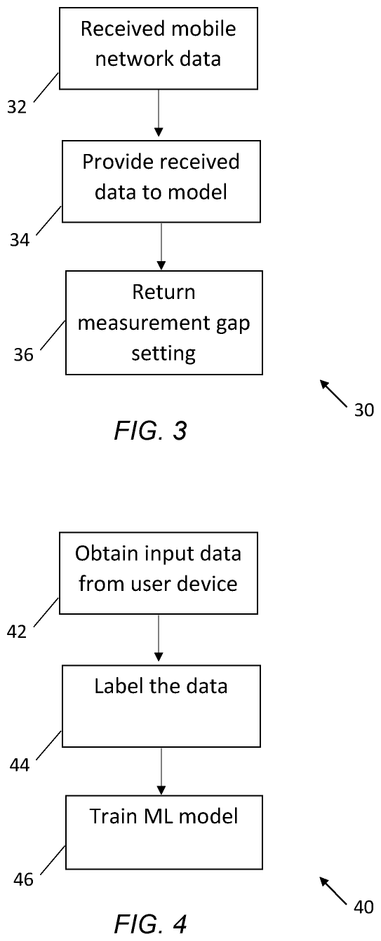

FIG. 3 is a flow chart showing an algorithm, indicated generally by the reference numeral 30, in accordance with an example embodiment. The algorithm 30 provides a mechanism for providing measurement gap settings for use in systems such as the system 10 described above.

The algorithm 30 starts at operation 32, where mobile communication network data for a user device is received. As discussed further below, the network data may include data such as serving cell reference signal received power (RSRP) value, user device mobility state, user device location in relation to distance from the cell centre, and a RRM relaxation parameter.

At operation 34, the received mobile communication network data is provided to a model for generating a measurement gap setting (e.g. a measurement gap pattern) based on the received data. As discussed above, the measurement gap setting defines measurement gap parameters for use in scheduling radio measurements of neighbouring cells. The measurement gap parameters may define one or more of intra-frequency, inter-frequency and inter-radio access technology measurements. As discussed further below, the measurement gap settings may seek to maximize average throughput with minimum (or no) effect on probability of handover failure (HOF).

The measurement gap settings may comprise a measurement gap repetition rate (MGRP) defining a periodicity of measurements and/or a measurement gap length (MGL).

At operation 36, the generated measurement gap setting is returned, for example to the user device, such that the user device can implement the measurement gap settings. The measurement gap setting may comprise one of a predefined plurality of measurement gap patterns. Thus, the operation 36 may indicate which of a number of predefined settings should be used.

Many parameters may be considered by the model in the operation 34. These include an RRM relaxation and a mobile state of the user device.

RRM relaxation refers to the degree to which measurement of neighbour cells is reduced. RRM relaxation may be used to enable a network (e.g. a 5G network) to reduce power consumption. When RRM relaxation is used, the complexity for assigning appropriate MGs may be increased. A low MG configuration (e.g. having a short MGRP) may be needed for a user device located at the cell centre that enabled RRM relaxation since this user device may reach the cell edge before the correct measurement gap is configured.

A model (e.g. a machine learning (ML) model) may be used in an implementation of the algorithm 30. For example, parameters such as one or more of the current user device location, serving cell RSRP, current mobility state, and last measurement state (e.g. considering radio resource management (RRM) relaxation) may be provided as inputs to the model. The output of the model can then be used to assign an appropriate MG setting for the respective user device. Note that the model could be implemented at either the user device or network side.

FIG. 4 is a flow chart showing an algorithm, indicated generally by the reference numeral 40, in accordance with an example embodiment. The algorithm 40 may be used for training the machine learning model described above.

The algorithm 40 starts at operation 42, where a set of input data is obtained from a user device (such as the user device 12) that is in communication with a mobile communication network (for which an MG setting is to be provided).

The input data can take many forms and may include one or more of: current location data for the user device; serving cell Reference Signal Received Power (RSRP); user device bandwidth; radio resource management (RRM) relaxation state; and a current mobility state of the user device. Other input data may be used in addition to, or instead of, at least some of the data described above. Much of these data are readily available at the network side where the algorithm 40 may be implemented.

At operation 44, the input data received in the operation 42 is labelled. As discussed in detail below, labelling may include indicating whether a handover occurred. Labelling the data enables supervised learning techniques to be used for training. In this way, a ML model may be trained that seeks to maximise throughput whilst minimising handover failures.

At operation 46, the model is trained (based on the labelled input data) by minimising a loss function. The trained model can then be used (for example in the algorithm 30) to generate a measurement gap setting defining parameters for use in scheduling radio measurements of neighbouring cells.

The model trained in the operation 46 can then be deployed in the network (e.g. to implement the algorithm 30 described above). The output of the model can be used to configure the measurement gap at the user device(s) of a mobile communications system.

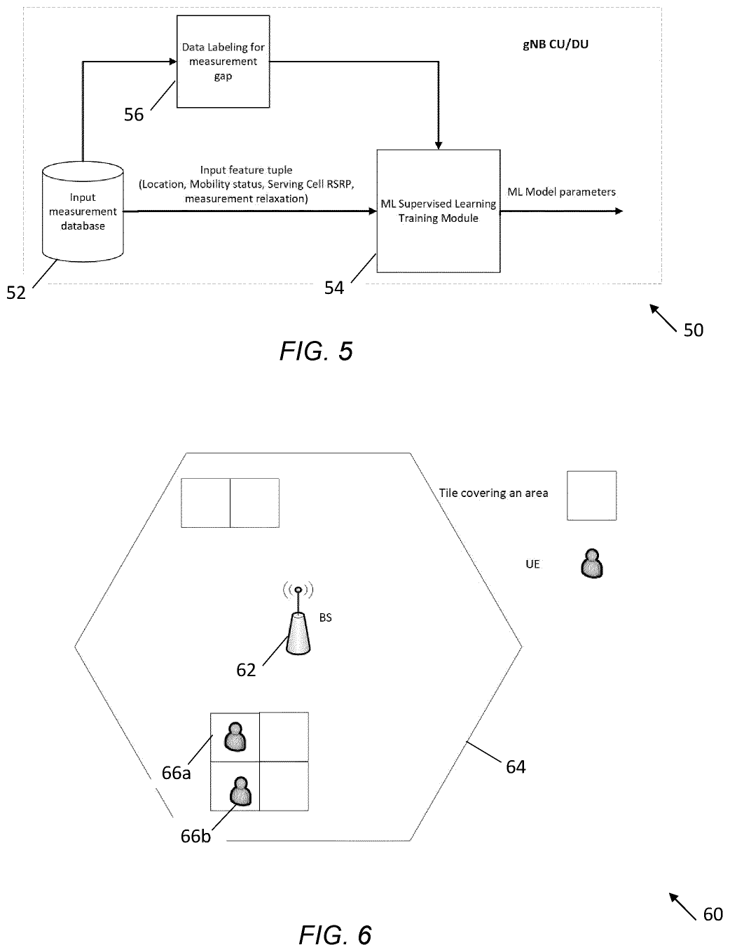

FIG. 5 is a block diagram of a system, indicated generally by the reference numeral 50, in accordance with an example embodiment. The system 50 may be used for implementing the algorithm 40.

The system 50 comprises an input measurement database 52, a training module 54 and a data labelling module 56.

A range of data may be obtained by the training module 54 from the input measurement database 52. As indicated in the system 50, these may include user device location, mobility status, serving cell RSRP and measurement relaxation.

The user device location may be available at the network (e.g. using an existing mechanism, such as GNSS). In many cases, an accurate user device location information is not particularly important; of more importance may be to be able to distinguish between a user device that is at or near a cell edge, at or near the cell centre or between those two extremes. For example, a determination of a “tile” within which the user device is located may be made.

By way of example, FIG. 6 is a block diagram of a system, indicated generally by the reference numeral 60, in accordance with an example embodiment. The system includes a base station 62 and an area 64 covered by the base station 62. A plurality of tiles are defined within the area 64 (of which a few are shown in FIG. 6). Two user devices 66a and 66b are shown in the system 60. Each user device is located within a tile. The identification of which tile the user device is located within may be sufficiently accurate for use as used device location data in the system 50.

Thus, the user device location may be pre-processed such that area within a given distance of a location is considered part of the same ‘tile’. Such a quantization of location can be used to reduce the amount of training data required to train an ML model without significantly affecting the performance of the model.

The mobility status provided to the training module 54 may indicate whether the mobility is high, medium or low. We could use numerical value 0, 1, 2 to represent these mobilities.

The serving cell beam RSRP may be reported by the user device and made available to the training module 54.

Measurement relaxation feature information may be estimated at the network side. Optionally, a signalling procedure may be provided to make the measurement relaxation state of the user device available at the network side. In one example embodiment, three measurement relaxation states are provided: fresh, aging and old (as discussed further below). Once again, these could be represented by using integers 0, 1 and 2.

The data provided to the training module 54 is labelled by the data labelling module 56. For example, assume that we have the following data:
Location=(X,Y)
Mobility status=A
S-cell RSRP=R
Measurement Relaxation=M

For a particular input tuple, an output measurement gap may be found by experimenting with using one of the output values and observing if it results in HOF.

In one example embodiment, we start conservatively by setting our hypothesis MG=20 ms and observing if this results in a handover failure (HOF). If not, we set MG=40 ms and repeat until we observe HOF with a particular MG. In this way, we set the largest measurement gap that does not result in HOF.

The labelling function may be implemented as follows:
For each input tuple:
   Select the largest MG that does not result in HOF
   Label output of the tuple with the selected MG

The training module 54 may be provided within a gNB-CU with more processing power or gNB-DU with smaller latency (close to UEs in a cell). After labelling the measurement data (as discussed above), the input data and labelled outputs are fed to supervised ML module for training. Feedforward neural networks are one example implementation of such a supervised learning model. The ML model is trained such that it minimizes a loss function (such as a mean square error-based loss function). After a fixed number of iterations or an early-stopping based criterion, ML model parameters are the output of the trained ML model (stored for inference).

The skilled person will be aware of many alternative arrangements for implementing and training the training module 54.

Once trained, the model can be placed in the network. The model could be placed in gNB-DU to reduce latency. Inference on MG can then performed based on an input tuple. It should be noted that an error evaluation may be continuously performed on MG inference. For example, if an MG output of machine learning inference is too large for a particular input tuple and results in HOF multiple times, this could be used to relabel the input tuple for future ML model training cycle.

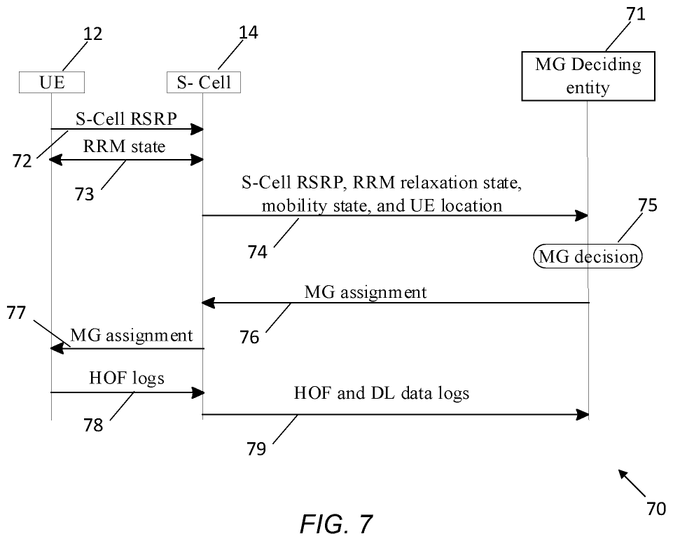

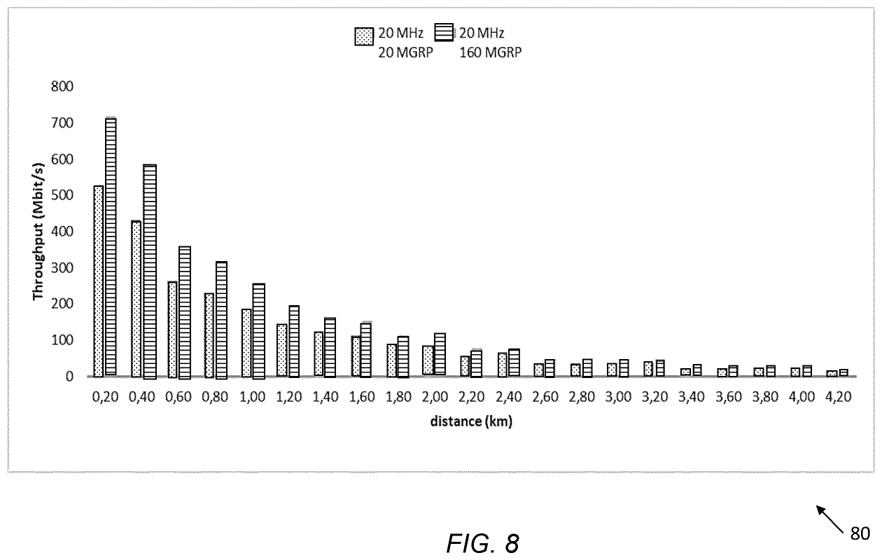

FIG. 7 is a message sequence, indicated generally by the reference numeral 70, in accordance with an example embodiment.

The message sequence 70 shows messages between the user device 12 and the serving cell 14 described above and a measurement gap (MG) deciding entity 71. The MG deciding entity 71 may be provided on the network side, but could be provided elsewhere (e.g. as part of the user device 12).

In the example message sequence 70, the serving cell RSRP is reported by the user device 12 to the serving cell in a message 72. The RRM relaxation state may not be known at the network side, so the network may estimate the RRM relaxation state or may request or require the user device to signal that state. This may require a new signalling (see the example messages 73 shown in the message sequence 70).

The inputs that are used for setting the measurement gap are channelled to the MG deciding entity 71 in a message 74. A decision 75 is made at the MMG deciding entity and the MG assignment is output from the deciding entity to the serving cell in a message 76 and to the user device in a message 77.

The message 77 may, for example, be an RRC re-configuration message that is used to configure the measurement gap status at the user device 12.

The user device 12 logs the handover failure (HOF) rate during the configured measurement gap status. The HOF logs are sent in the radio link failure report (see message 78). The network logs the DL data that is supposed to be sent to UE during the MG.

The network provides the HOF and DL data log data to the MG deciding entity (message 79). The MG deciding entity 71 can then use the HOF and data log information to optimise the MG allocation and re-train the ML algorithm.

Thus, a machine-learning approach is provided, at the network side, to take into account the current conditions on the user device side and to assign an appropriate measurement gap (MG).

Table 1 below presents data for a case when a user device (UE) is at the cell centre. The RSRP and mobility data are each divided into three categories (low, medium, and high) and similarly last measurement state is divided into fresh, aging, and old categories. The algorithm is trained in such a way that when the last measurement is old with high/medium mobility, the algorithm configures low MGs to reduce the HOFs. When the mobility is low (e.g. a pedestrian user), the algorithm chooses high MG even at the old state of the last measurement to enhance the throughput. In all other cases for the cell centre, the algorithm selects high MGs to improve the throughput.

TABLE 1
Example Measurement Gap assignments for cell-center UEs

| | | RRM relaxation | | | |
|---|---|---|---|---|---|
| Serving | | (last measurement | Measurement | | |
| RSRP | Mobility | state) | Gap | | Reason |
| High | High | Fresh | 160 | ms | To improve throughput |
| High | High | Aging | 80 | ms | To improve throughput |
| High | High | Old | 20 | ms | To reduce HOFs |
| High | Medium | Fresh | 160 | ms | To improve throughput |
| High | Medium | Aging | 80 | ms | To improve throughput |
| High | Medium | Old | 40 | ms | To reduce HOFs |
| High | Low | Fresh | 160 | ms | To improve throughput |
| High | Low | Aging | 160 | ms | To improve throughput |
| High | Low | Old | 80 | ms | To improve throughput |

Similarly, Table 2 provides a use case in which a user device (UE) is at the cell edge. In this example, no matter matter what the UE conditions are at the cell edge, the algorithm will choose low MGs to reduce the HOFs. This is to avoid compromising the HOFs by reducing throughput. In simple words, continuous connectivity is more important than increased throughput for this specific case.

TABLE 2
Example Measurement Gap assignments for cell-edge UEs

| Serving | | RRM relaxation (last | Measurement | |
|---|---|---|---|---|
| RSRP | Mobility | measurement state) | Gap | Reason |
| Low | High | Fresh | 20 ms | To reduce HOFs |
| Low | High | Aging | 20 ms | To reduce HOFs |
| Low | High | Old | 20 ms | To reduce HOFs |
| Low | Medium | Fresh | 20 ms | To reduce HOFs |
| Low | Medium | Aging | 20 ms | To reduce HOFs |
| Low | Medium | Old | 20 ms | To reduce HOFs |
| Low | Low | Fresh | 40 ms | To reduce HOFs |
| Low | Low | Old | 20 ms | To reduce HOFs |
| Low | Low | Aging | 20 ms | To reduce HOFs |

Further, Table 3 provides a use case in which a user device (UE) is located in-between the cell edge and the cell centre. For this case, the algorithm more carefully chooses the MGs as the UE may reach the cell centre or cell edge in a few seconds. As shown in Table 3, the algorithm chooses low MGs when RRM relaxation is enabled and UE mobility is high. In the case of no measurement relaxation, the algorithm chooses high MGs to increase the throughput. At low speed and medium to high RSRP, the algorithm can configure high MGs even if RRM relaxation is configured especially for the “Aging” category. Even though different parameters are presented as three specific levels, in real world examples, most of them are continuous parameters and it is a challenge to decide which value would map to these 3 specific levels. Considering the challenge of doing MG assignment with continuous values, a machine-learning approach, as described herein, may be advantageous.

TABLE 3
Example Measurement Gap assignments for in-between UEs

| | | RRM relaxation | | | |
|---|---|---|---|---|---|
| | | (last | | | |
| Serving | | measurement | Measurement | | |
| RSRP | Mobility | state) | Gap | | Reason |
| High | high | Fresh | 160 | ms | To improve throughput |
| High | high | Aging | 40 | ms | To reduce HOFs |
| High | high | Old | 20 | ms | To reduce HOFs |
| Medium | high | Fresh | 80 | ms | To improve throughput |
| Medium | high | Aging | 20 | ms | To reduce HOFs |
| Medium | high | Old | 20 | ms | To reduce HOFs |
| Low | high | Fresh | 80 | ms | To improve throughput |
| Low | high | Aging | 20 | ms | To reduce HOFs |
| Low | high | Old | 20 | ms | To reduce HOFs |
| High | Low | Fresh | 160 | ms | To improve throughput |
| High | Low | Aging | 80 | ms | To improve throughput |
| High | Low | Old | 40 | ms | To reduce HOFs |
| Medium | Low | Fresh | 160 | ms | To improve throughput |
| Medium | Low | Aging | 80 | ms | To improve throughput |
| Medium | Low | Old | 20 | ms | To reduce HOFs |
| Low | Low | Fresh | 80 | ms | To improve throughput |
| Low | Low | Aging | 20 | ms | To reduce HOFs |
| Low | Low | Old | 20 | ms | To reduce HOFs |

The throughput improvement that may be achieved by providing an appropriate measurement gap can be observed in the below simulation results.

In the below simulations, the spectral efficiency is calculated in accordance with the TR 37.910. The throughput is calculated for a single time-instance. Eight-layer downlink transmission is assumed with varying modulation and coding rates with respect to the distance of the UE to the base station. Friis path loss model is considered and a noise floor of −96 dBm is assumed for 2.1 GHz carrier frequency and 10 dBm transmit power with no additional receive or transmission antenna gain. No interference is assumed. MCS spectral efficiency versus SNR is assumed to vary between 0.15 to 5.5 bits/second/Hz. An overhead of 2 symbols for each 14 symbols are assumed for each slot. A scaling factor of 1 is used assuming a generic UE. It was assumed that the UE can be allocated all the bandwidth and the UE has a full buffer.

FIG. 8 is a plot, indicated generally by the reference numeral 80, showing throughput for a user device in accordance with an example embodiment. In the plot 80, a 20 MHz bandwidth user device is configured with either 20 ms (indicated with dotted bars) or 160 ms (indicated with horizontally striped bars) measurement gap repetition (MGRP) with 6 ms measurement gap length (MGL).

In the plot 80, the maximum throughput in Mbit/s of the user device (UE) is plotted on the y-axis while the distance of the user device to the base station (BS) in km is plotted on the x-axis. The user device supports a 20 MHz bandwidth. A user device that is 200 meters away to the BS can achieve 716 Mbit/s throughput at maximum with a 160 ms MGRP, while it can achieve 528 Mbit/s throughput with a 20 ms MGRP. This is a throughput reduction of 26% and a difference of 188 Mbit/s for the cell centre user device if it is configured with a sub-optimal measurement gap.

For the user device that is 2 kms away to the BS, the user device can achieve 113 Mbit/s throughput at maximum with a 160 ms MGRP, while it can achieve 83 Mbit/s throughput with a 20 ms MGRP. This is a reduction of 30 Mbit/s for the in-between user device if it is configured with a sub-optimal measurement gap. But at large distance, the throughput gain by using high MGRP is low and we do not want the risk of handover failure so 20 ms MGRP is good at cell edge regardless of other inputs.

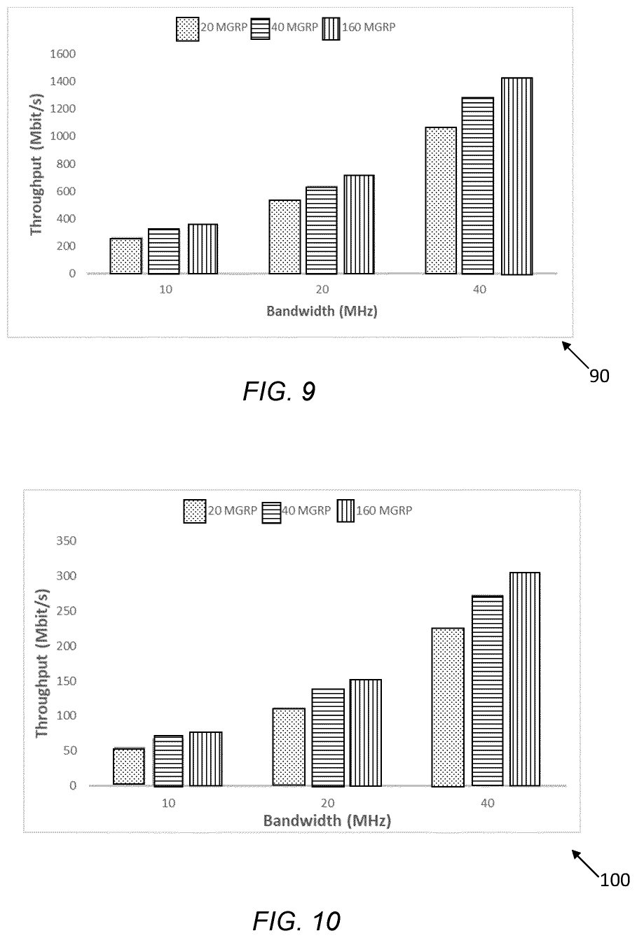

FIGS. 9 and 10 are plots, indicated generally by the reference numerals 90 and 100 respectively, showing throughputs for user devices in accordance with example embodiments. In the plots 90 and 100, 10 MHz, 20 MHz and 40 MHz bandwidth user device are configured with either 20 ms (indicated with dotted bars), 40 ms (indicated with horizontally striped bars) or 160 ms (indicated with vertically striped bars) measurement gap repetition (MGRP) with 6 ms measurement gap length (MGL).

In the plot 90, the user device is at the cell centre. In the plot 100, the user device is between the cell centre and the cell edge.

In the plots 90 and 100, the maximum throughput in Mbit/s the user device is plotted on the y-axis while the x-axis depicts different BW configurations of the user device.

With the user device at the cell centre with 40 MHz bandwidth (see FIG. 9), the user device can achieve 1433 Mbit/s throughput with a 160 ms MGRP, while it can achieve 1280 Mbit/s throughput with a 40 ms MGRP and 1043 with a 20 ms MGRP. This is a throughput reduction of 27% between 160 ms MGRP and 20 MGRP and 18% between 40 ms MGRP and 20 ms MGRP. The difference of almost 400 Mbit/s between 160 MGRP and 20 MGRP and 150 Mbit/s between 160 MGRP and 40 MGRP. We assume that this throughput is lost in case the user device is configured with a measurement gap of 40 MGRP or 20 MGRP when it can sustain measurements with 20 MGRP.

In FIG. 10, with the user device between cell centre and cell edge at a distance of 1 km to the BS, with 40 MHz bandwidth, the user device can achieve 304 Mbit/s throughput with a 160 ms MGRP, while it can achieve 272 Mbit/s throughput with a 40 ms MGRP and 224 with a 20 ms MGRP. This is a throughput reduction of 26% between 160 ms MGRP and 20 MGRP and 18% between 40 ms MGRP and 20 ms MGRP. The difference of almost 80 Mbit/s between 160 MGRP and 20 MGRP and 32 Mbit/s between 160 MGRP and 40 MGRP.

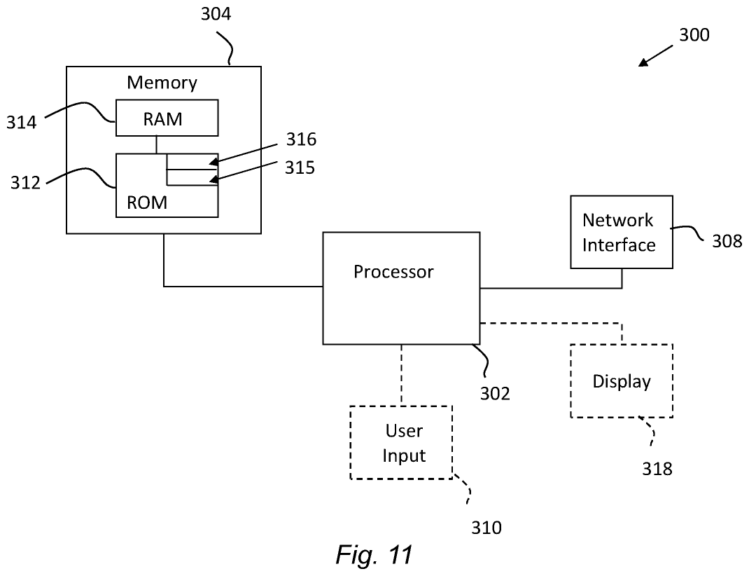

For completeness, FIG. 11 is a schematic diagram of components of one or more of the example embodiments described previously, which hereafter are referred to generically as a processing system 300. The processing system 300 may, for example, be the apparatus referred to in the claims below.

The processing system 300 may have a processor 302, a memory 304 closely coupled to the processor and comprised of a RAM 314 and a ROM 312, and, optionally, a user input 310 and a display 318. The processing system 300 may comprise one or more network/apparatus interfaces 308 for connection to a network/apparatus, e.g. a modem which may be wired or wireless. The network/apparatus interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain code which, when executed by the processor implements aspects of the algorithms 30 and 40 and the message sequence 70 described above. Note that in the case of small device/apparatus the memory can be most suitable for small size usage i.e. not always a hard disk drive (HDD) or a solid state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size.

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

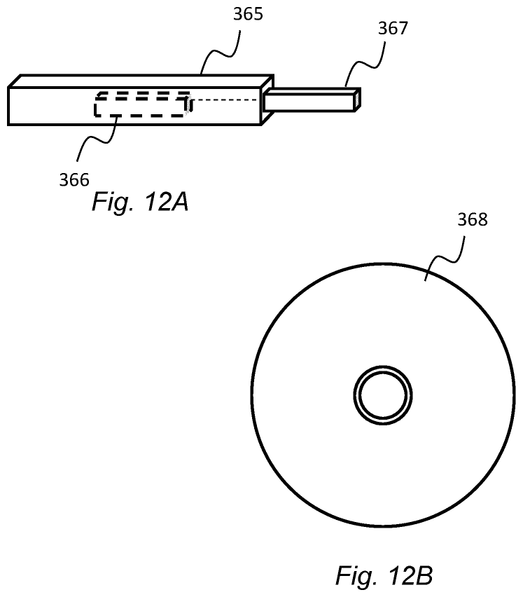

FIGS. 12A and 12B show tangible media, respectively a removable memory unit 365 and a compact disc (CD) 368, storing computer-readable code which when run by a computer may perform methods according to example embodiments described above.

The removable memory unit 365 may be a memory stick, e.g. a USB memory stick, having internal memory 366 storing the computer-readable code. The internal memory 366 may be accessed by a computer system via a connector 367. The CD 368 may be a CD-ROM or a DVD or similar. Other forms of tangible storage media may be used. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

If desired, the different functions discussed herein may be performed in a different order and/or concurrently with each other. Furthermore, if desired, one or more of the above-described functions may be optional or may be combined. Similarly, it will also be appreciated that the flow diagrams and message sequences of FIGS. 3, 4 and 7 are examples only and that various operations depicted therein may be omitted, reordered and/or combined.

It will be appreciated that the above described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. An apparatus comprising means for performing:
receiving mobile communication network data for a user device;
providing the received mobile communication network data to a model for generating a measurement gap setting based on the received data, wherein the measurement gap setting defines measurement gap parameters for use in scheduling radio measurements of neighbouring cells; and
returning the generated measurement gap setting.

2. The apparatus of claim 1, wherein the measurement gap parameters define one or more of intra-frequency, inter-frequency and inter-radio access technology measurements.

3. The apparatus of claim 1, wherein the measurement gap setting comprises a measurement gap repetition rate defining a periodicity of measurements.

4. The apparatus of claim 1, wherein the measurement gap setting comprises a measurement gap length.

5. The apparatus of claim 1, wherein the measurement gap setting comprises one of a predefined plurality of measurement gap patterns.

6. The apparatus of claim 1, wherein the mobile communication network data comprises one or more of:
current location data for the user device;
serving cell Reference Signal Received Power;
user device bandwidth;
radio resource management relaxation state; and
a current mobility state of the user device.

7. The apparatus of claim 6, wherein the current location data for the user device indicates whether the device is at a cell centre, at cell edge or in-between the cell centre and cell edge.

8. The apparatus of claim 1, wherein the model is a machine learning model.

9. The apparatus of claim 8, further comprising means for performing: training said machine learning model.

10. The apparatus of claim 9, wherein the means for performing training said machine learning model comprises means for performing:
obtaining a set of input data from the user device;
labelling the data, including indicating whether a handover occurred; and
training the model by minimising a loss function.

11.-13. (canceled)

14. A method comprising:
receiving mobile communication network data for a user device;
providing the received mobile communication network data to a model for generating a measurement gap setting based on the received data, wherein the measurement gap setting defines measurement gap parameters for use in scheduling radio measurements of neighbouring cells; and
returning the generated measurement gap setting.

15. A computer program comprising instructions for causing an apparatus to perform at least the following:
receiving mobile communication network data for a user device;
providing the received mobile communication network data to a model for generating a measurement gap setting based on the received data, wherein the measurement gap setting defines measurement gap parameters for use in scheduling radio measurements of neighbouring cells; and
returning the generated measurement gap setting.

16. The method of claim 14, wherein the measurement gap parameters define one or more of intra-frequency, inter-frequency and inter-radio access technology measurements.

17. The method of claim 14, wherein the measurement gap setting comprises a measurement gap repetition rate defining a periodicity of measurements.

18. The method of claim 14, wherein the measurement gap setting comprises a measurement gap length.

19. The method of claim 14, wherein the measurement gap setting comprises one of a predefined plurality of measurement gap patterns.

20. The computer program of claim 15, wherein the measurement gap parameters define one or more of intra-frequency, inter-frequency and inter-radio access technology measurements.

21. The computer program of claim 15, wherein the measurement gap setting comprises a measurement gap repetition rate defining a periodicity of measurements.

22. The computer program of claim 15, wherein the measurement gap setting comprises a measurement gap length.

23. The computer program of claim 15, wherein the measurement gap setting comprises one of a predefined plurality of measurement gap patterns.
